(19) United States
(12) Patent Application Publication
(10) Pub. No.: US 2016/0205385 A1
(43) Pub. Date: Jul. 14, 2016

(54) HOLOSCOPE DIGITAL VIRTUAL OBJECT PROJECTOR

(71) Applicant: Thomas S Sibley, Sante Fe, NM (US)

(72) Inventor: Thomas S Sibley, Sante Fe, NM (US)

(21) Appl. No.: 14/392,375

(22) PCT Filed: Aug. 26, 2014
(86) PCT No.: PCT/US14/52761

§ 371 Date: Feb. 27, 2016

(51) Int. Cl. H04N 13/04; G02B 1/00; G02B 26/08; G02B 27/22; G02B 5/09

(52) U.S. Cl. CPC H04N 13/0402; H04N 13/0488; G02B 27/2271; G02B 5/09; G02B 26/0816; G02B 1/002

(57) ABSTRACT

Disclosed is a digital virtual object projector capable of projecting an auto-stereoscopic, 3D, high definition, virtual object or motion graphic upon three-dimensional space. Producing a collective, interactive, virtual platform viewable from multiple angles, the Holoscope is adaptable to a variety of digital imaging applications and can support traditional imaging formats. The Holoscope can project an auto-stereoscopic, 3D object at an improved resolution, frame rate, size, and cost than was heretofore possible. The Holoscope offers a unique form of auto-stereoscopic display and spatially augmented, virtual environment.

### CROSS-REFERENCE TO RELATED APPLICATIONS

The present application is a Continuation In Part of application Ser. No. 14/010,766 filed on Aug. 27, 2013 The current status is pending.

### STATEMENT REGARDING FEDERALLY SPONSORED RESEARCH OR DEVELOPMENT

None.

### NAMES OF THE PARTIES TO A JOINT RESEARCH AGREEMENT

None.

### REFERENCE TO A SEQUENCE LISTING

None.

### STATEMENT REGARDING PRIOR DISCLOSURES BY ANY INVENTORS

None.

### BACKGROUND OF THE INVENTION

1. Field of the Invention

The present invention is a digital virtual object projector, which projects an auto-stereoscopic, 3D, high definition, virtual object or motion graphic onto 3D space without the need of a headset, optical substrate, or enclosure. It uses a target object, one or several micro-projectors, a parabolic mirror assembly, and specifically formatted visual information to produce a virtual, 3D display and spatially augmented reality.

2. Description of the Prior Art

Current versions of auto-stereoscopic, 3D, holographic or virtual object displays and projection systems often depend upon optical substrates such as emulsive films, liquid crystal displays, or other semi-transparent screens and materials to display auto-stereoscopic, 3D objects and forms. Current auto-stereoscopic, 3D display technology exists that can generate a virtual image without an optical substrate, however images remain low resolution, monochromatic, simple graphics with slow refresh rates. While auto-stereoscopic, 3D visualization technologies exist, which deliver high-resolution graphics and resemble holograms, they remain dependent upon enclosures and optical substrates for their viewing environment. The drawback of such systems is that they are not viewable from multiple angles and do not produce an independent virtual object or spatially augmented reality. Further, they often require expensive hardware configurations to function and depend upon rotational elements, which are subject to mechanical failure, reduced scalability, and limit the resolution of auto-stereoscopic content.

U.S. Pat. No. 8,502,816 describes a tabletop display providing multiple auto-stereoscopic views to users, comprising a rotatable view-angle restrictive filter and a display system. The display system displays a sequence of images synchronized with the rotation of the filter to provide multiple views according to viewing angle. These multiple views provide a user with a 3D display or with personalized content, which is not visible to a user at a sufficiently different viewing angle. In some embodiments, the display comprises a diffuser layer on which the sequence of images are displayed.

This system is limited by it's a rotatable view-angle restrictive filter and a display system, which does not permit high resolution or complex auto-stereoscopic images to be used due to its image source. It employs an electro-optic directional (e.g. holographic) filter which is a rotating element, subject to mechanical failure and limited scalability. This type of an electro-optic directional filter does not permit a high resolution, motion graphic to be displayed at the current time.

U.S. Pat. No. 7,881,822 describes a system and method for selling and/or dispensing consumer products from a vending or transactional-based machine. The vending or transactional-based machine comprises an aerial display device that displays an aerial image designed to attract the attention of potential consumers and sell advertising, special promotions or certain products.

This system describes itself as an aerial display system for displaying a changing, three-dimensional aerial image of products being sold. However, designed for kiosks and vending machines, it is accordingly encased within an enclosure and as such is not viewable from multiple sides.

U.S. Pat. No. 5,865,519 describes an apparatus for representing moving images in the background of a stage, using an image source, which projects an image on to a reflecting surface on the floor. Behind the reflecting surface, a transparent smooth foil extends at 45° from the ceiling to the floor. The image produced by the image source appears to the viewers as a virtual image behind the foil.

This system is limited by its use of an optical substrate, which is in this case a transparent smooth foil. The optical substrate provides one perspective to the viewing audience and does not generate an auto-stereoscopic, 3D object with multiple viewing angles or volume. It is designed for a theater environment.

### SUMMARY OF THE INVENTION

The present invention is a device that projects an auto-stereoscopic, high definition, virtual object or motion graphic onto three-dimensional space without the need of an optical substrate or enclosure. It uses one or several micro-projectors to project an auto-stereoscopic, 3D form upon a target object. The target object is converted into a virtual object by a parabolic mirror assembly. The mirrors convert and project the target object as a virtual object through interference patterns. The present invention is an auto-stereoscopic, virtual display that produces a new form of spatially augmented reality.

It is therefore a primary object of the present invention to provide an imaging platform for gaming, digital entertainment media, digital cinema, television, Internet content, smart phones, tablets and the next generation of personal digital assistants and mobile devices.

It is another object of the present invention to provide a 3D viewing platform for 3D medical imaging technologies, including, but not limited to: computed tomography (CT), magnetic resonance imaging (MRI), nuclear medicine imaging (NMI), radiography (X-Ray), and Ultrasound. It could also be used to display several layered medical imaging platforms to increase diagnostic proficiency.

It is still another object of the present invention to provide remote navigational imaging for an unmanned aerial vehicle (UAV), remotely piloted vehicle (RPV), remotely piloted aircraft (RPA), autonomous underwater explorer (UAE), space exploration vehicle (SEV), or any form of remotely piloted or autonomous device. It would have the ability to display information from an autonomous or remote vehicle's camera and sensors and display the perspective in first person, axonometric, and other remotely generated perspectives. It would have the ability to relay topographically accurate terrain data. It could also be used to view microscopic and spectral information acquired by exploration vehicles.

It is yet an additional object to provide an immersive virtual reality environment with a matrix of modular devices of varying sizes. This could also be achieved through increased mirror diameter, depth, segmented mirrors, and optical augmentation to create computer generated or reality based virtual reality environment.

It is a further object of the present invention to provide a tele-presence interface to reproduce the partial or complete human form in real time and increase the human interactivity of tele-presence and tele-conferencing.

It is yet a further object to provide a 3D image preview prior to fabrication for 3D printing, scanning, and CAD/CAM applications.

It is still a further object to provide an imaging platform for geological and geophysical data, including, but not limited to: remote imaging, exploration geophysics, surface and subsurface imaging, onshore and offshore seismology, magnetometric and gravimetric data, raw logging data, 2-D seismic interpretation, Ethology, Interactive Surface Modeling™ (ISM), interactive volume modeling, (IVM), electronic spectral sensors, Vidicon, multispectral scanner imagery, airborne photography, imaging spectroscopy, thermal and visible imaging, digitized gravity imaging, airborne visible and infrared imaging spectrometry (AVIRIS), side scan sonar, and Landsat MSS data.

It is still a further object to provide an imaging platform for advertising, commercial product demonstration and display.

It is also a further object to provide an imaging platform for scientific modeling and predictive simulation science, including, but not limited to: finite element modeling, molecular modeling, materials modeling, atmospheric modeling, phenomenological modeling, and higher dimensional visualization.

It is another object of the present invention to provide a virtual interactive teaching/instructional toy/tool for children and adults. It would project virtual instructors/instruction, educational graphics and applications to enhance remote collaborations between teacher and student.

It is an additional object of the present invention to provide an imaging system to convey dynamic and accurate real time data visualization systems for aviation and weather RADAR, SONAR and GPS systems.

It is yet a further object to provide virtual display/dashboard for cars, planes and other vehicles.

It is still a further object to provide a viewing interface for design applications and demonstrations.

It is an additional object to provide an imaging platform for microscopes and telescopes.

These and other objects of the present invention will become apparent to those familiar with the art upon reading the accompanying description, drawings, and claims set forth herein. The headings provided herein are for the convenience of the reader only. No headings should be construed to limiting upon the content in any way.

### BRIEF DESCRIPTION OF THE DRAWINGS

FIG. 1 is a side section view of the Holoscope: digital virtual object projector according to the present invention.

FIG. 2 is a top section view of the Holoscope: digital virtual object projector: present invention taken along line 2-2 of FIG. 1

FIG. 3 is a side section view of the Holoscope: digital virtual object projector in its segmented (deformable) mirror version according to the present invention.

FIG. 4 is a top section view of the Holoscope: digital virtual object projector in its segmented (deformable) mirror version: according to present invention.

FIG. 5 is a side section view of the capture prism according to the present invention.

FIG. 6 is a top section view of the capture prism according to the present invention.

FIG. 7 is a diagram illustrating a method for capturing sections of real objects and re-assembling them as three-dimensional, virtual objects from captured three-dimensional sections

FIG. 8 is a diagram illustrating a method for capturing different segments of a 3-D, object and reassembling an object from composite camera perspectives.

FIG. 9 is a diagram for illustrating a method for formatting different segments of a three-dimensional object in sequential states of rotation to re-assemble as a rotating 3-D object.

FIG. 10 is a diagram for illustrating a method for generating 3-D objects and events without a mirror assembly and/or target object.

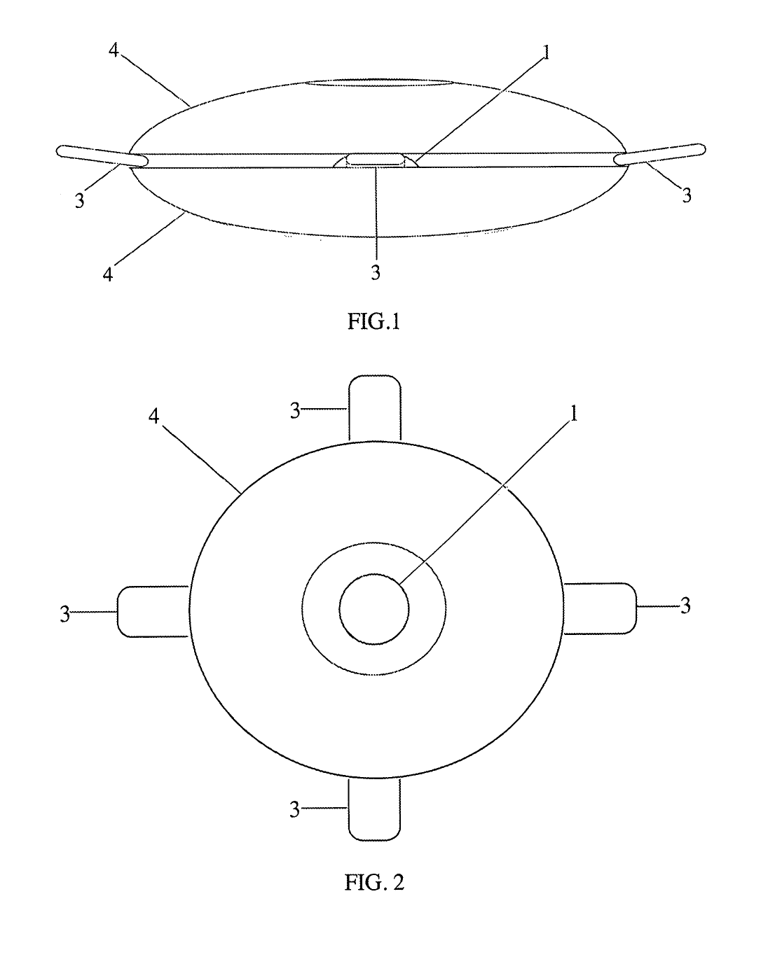

### DETAILED DESCRIPTION OF THE INVENTION

### 1. Definitions

Target object as used herein shall mean a real object that acts as a 3D screen upon which one or several micro-projectors project visual information.

Target object as used herein may include solid geometries and/or capture prisms which convert multiple 2-D projections to volumetric form.

Capture prism as used herein shall mean intersecting reflective screens imbedded in acrylic and/or other optical materials shaped as cylinders or other geometries which impart volumetric properties on internal projective screens or liquid crystal displays inside the capture prism to render the same effect and eliminate the need for projectors.

Micro-projectors as used herein shall mean small projectors which are of an appropriate focal length to project on the target object and are small enough to work partially inside the parabolic mirror assembly.

The parabolic mirror assembly as used herein shall mean an assembly of two parabolic mirrors and/or deformable mirrors facing each other and separated at an optimal distance with apertures at the top and bottom to generate interference patterns and allow projections from beneath if required.

Cameras as used herein shall mean actual cameras or 3-D modeling based cameras in 3-D modeling software. Laser scanners and other scanning and capturing devices may be substituted for cameras.

Micro-projectors and projectors as used herein shall be interchangeable terms.

Object and form as used herein shall be interchangeable terms.

Holoscope and digital virtual object projector as used herein shall be interchangeable terms.

### 2. Best Mode of Invention

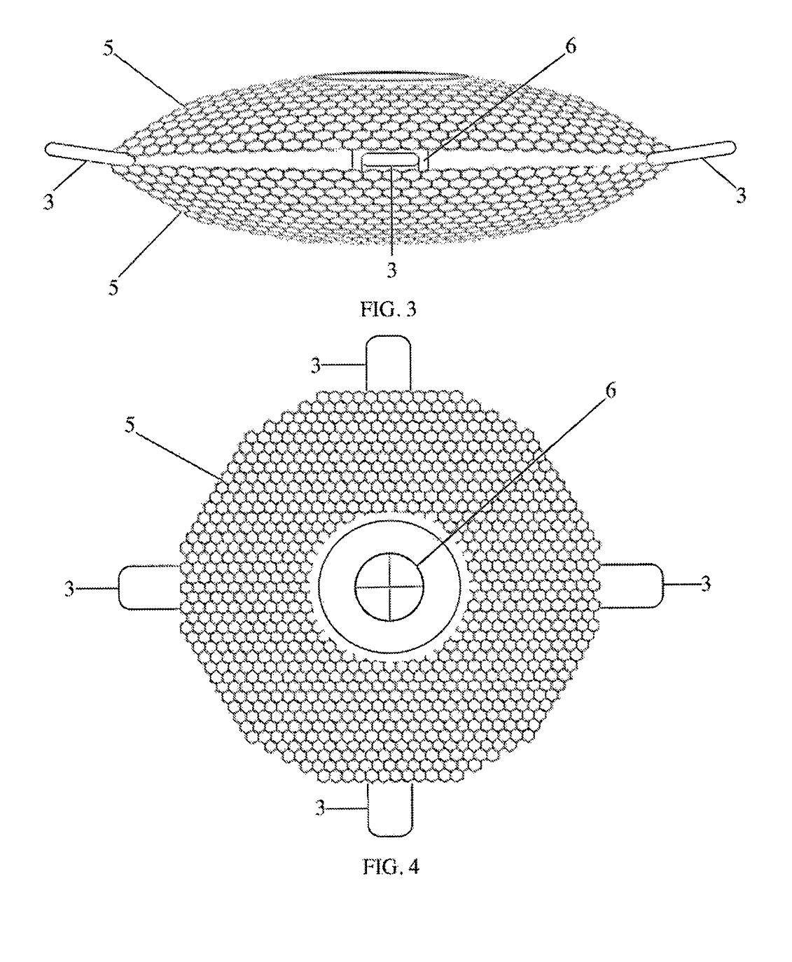

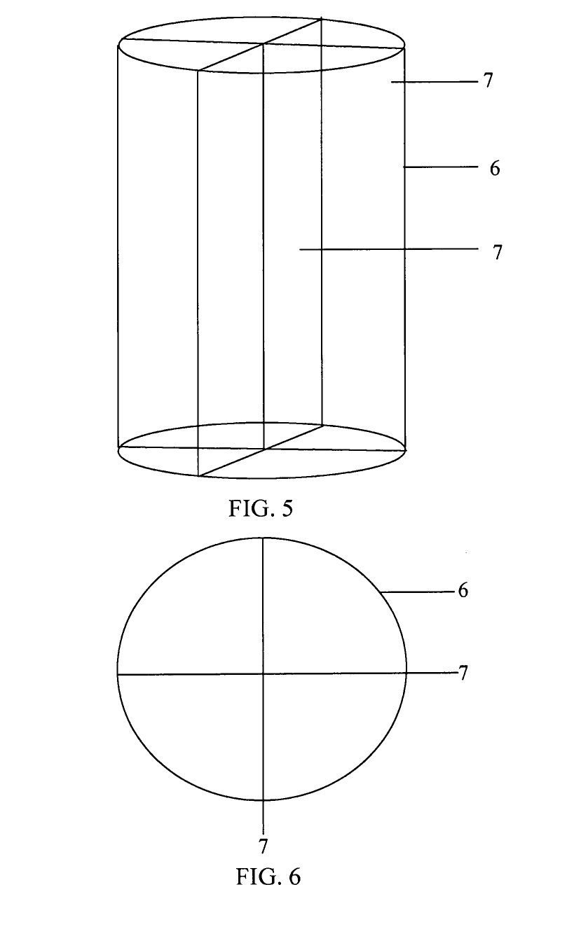

FIG. 3 shows a side sectional view of the best mode contemplated by the inventor of the digital virtual object projector according to the concept of the present invention.

### 3. How to Make the Invention

As can be seen amply from the drawings, the Holoscope is a device comprised of single (2) or several micro-projectors (3), target object (1) or capture prism (6), and parabolic mirror assembly (4) or deformable mirror array assembly (6). These components work together to project an auto-stereoscopic, 3D, digital virtual object or form onto three-dimensional space that can be viewed from a single or several angles.

The target object (1) is a real object and the focal point of one or several micro-projectors. The target object (1) in this case is a sphere with a reflective surface. Spherical geometry has proven thus far the most seamless, solid 3-D form to project upon, though any regular or irregular polyhedron with a reflective surface can be used, provided the projected information is segment formatted for the target object's geometry. The target object (1) acts as a spherical projection screen upon which 3-D forms are projected. It works in conjunction with specifically formatted information. The target object (1) is a real object at the base of the parabolic mirror assembly (4). The target object (1) is comprised of both the real object and it's reflected surface information. The target object is converted into a virtual object by the parabolic mirror assembly. (4) A solid target object such as a sphere works best in a fixed perspective system.

The target object (1) is a real object and the focal point of one or several micro-projectors. The target object (1) in this case is a capture prism (5) or optical grade, acrylic cylinder, and or other geometry formed of optical material, sectioned, and enclosing intersecting opaque or semi-transparent, projection screens (7). The capture prism's internal projection screens (7) act as intersecting surfaces upon which composite sections of 3-D objects are projected from four sides at 90 degree increments and converge at the center. The capture prism's (5) optical properties of internal curvature impart volumetric and anamorphic properties upon the projection screens (7) or liquid crystal displays inside the capture prism. The internal projection screens work as barriers and convergence points between the 90 degree sections of the capture prism though semi-transparent screens can also be used for rear projection. While the capture prism can be based on any regular or irregular polyhedron, the cylindrical, capture prism (5) exhibits the most promising internal curvature thus far. The capture prism (5) is comprised of both a real object (segmented, acrylic cylinder) and it's reflected internal information (internal projection screens or liquid crystal displays. The target object (1) or capture prism (5) is a real object at the base of the parabolic mirror (4) and/or deformable mirror array (3). The capture prism is converted into a virtual object by the parabolic (4) and/or deformable mirror array (5). The capture prism is the most effective means for laser-based projectors to composite a 360 degree, volumetric object or event, observable to one or more viewers from multiple sides. Quantity and design of internal projection screens may vary due to variations in the capture prism's design and geometry.

Micro-projectors (3) are used to convey the visual information to the target object (1). A single projector (2) can be used to project a 3-D virtual object observable from a fixed point of view. A micro-projector array (3) is used to project a composite object viewable from multiple sides. Each object segment is projected from a single projector (2). The segmented object projection can be produced by as few as two micro-projectors (3) or as many as are required to cover the surface area of the target object (1). The micro-projectors (3) are arrayed to project upon the target object (1) in segments. Four micro-projectors are used for the diagram, but the number of projectors used is relative to the size and shape of the target sphere as is their arrangement. Additional micro-projectors (3) can be added from above and below when necessitated by modifications in the target sphere (1).

The parabolic mirror assembly (4) is comprised of two concave parabolic mirrors (4) interfaced with circular apertures at the bottom and top. The two parabolic mirrors (4) magnify and project a virtual object of whatever real object is placed inside the mirrors at their base. The real or target object (1) and it's reflected surface information are converted into a virtual object through the generation of interference patterns by the mirror assembly (4). An increase in the diameter of the mirror assembly results in the increase in the size of the virtual object. However, increases in the scale of projection could also be increased by optical augmentation, variations in mirror depth and segmented mirrors. The mirror assembly may eventually be replaced by interference patterns generated directly by lasers, micro-projectors or some other projective source.

The deformable mirror array assembly (5) is in this case comprised of two, segmented, polygonal mirror arrays (5) interfaced with apertures at the top and bottom. The two deformable mirrors (5) magnify, project, and variate the focal point and wave front of the virtual object or whatever reflected target object (1) and/or capture prism (6) is placed inside the deformable mirror assembly at its base. The capture prism (6) and its internal projection screens (7) are converted into a virtual object through interference patterns by the deformable mirror array assembly (5). Deformable mirrors (5), such as but not limited to segmented mirror arrays (5) contract and expand the segmented array of polygonal mirrors to control mirror depth, wave front of light, interference patterns and focal point of the virtual object. An increase in the diameter of the deformable mirror assembly (5) results in the increase in the size of the virtual object. However, non-linear meta-surface mirrors can also be used in conjunction with deformable mirror technology to increase the frequency output and/or size of virtual object. The mirror assembly may eventually be replaced by interference patterns generated directly by lasers, micro-projectors, and/or some other projective source. The polygonal array (5) is merely one example and the polygonal mirror array may be based on any periodic, aperiodic, or non-periodic tiling patterns and/or regular or irregular tessellations. Deformable mirror designs may consist of less or more polygonal iterations or repetitions than are depicted by the diagram.

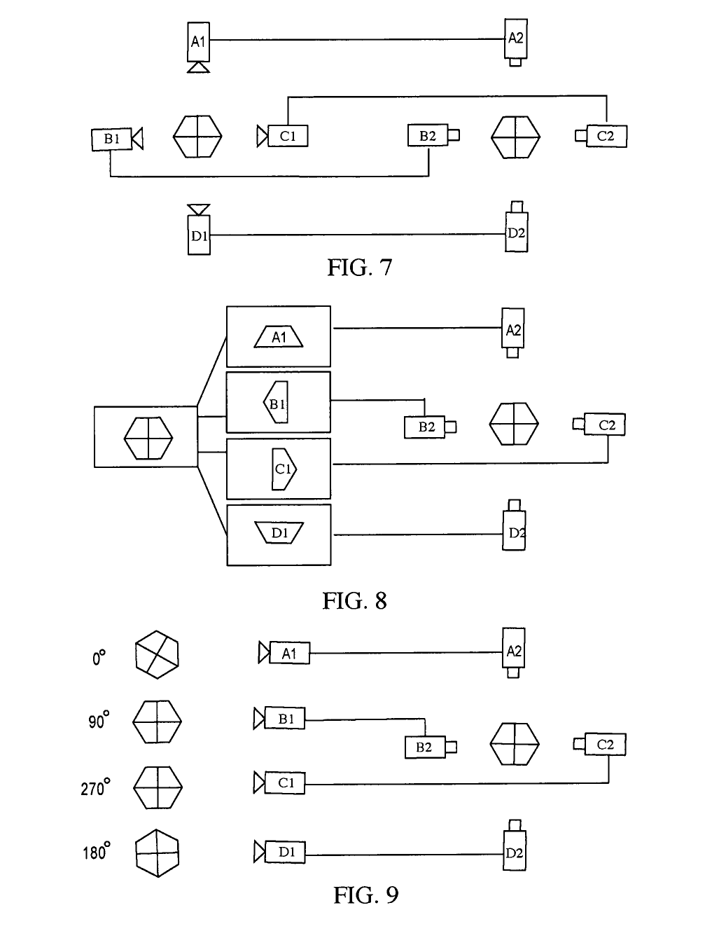

FIG. 7 is a diagram illustrating the method for capturing real objects and re-assembling three-dimensional sections of real objects into three-dimensional sections of virtual objects. Camera (A1) through (D1) capture the real object and send the view angle to alphanumeric projector pairs (A2) through (D2). The system can be comprised of one or several camera angles and projector pairs. While the number of cameras and camera angles are specific to this particular system, variations in capture prism designs may require any number of cameras, capture angles, and projectors. Laser scanners and other scanning and capturing devices may be substituted for cameras.

FIG. 8 is a diagram illustrating a method for formatting different segments of a three-dimensional, virtual object with 3-D modeling based cameras in a 3-D modeling software program such as CAD and sending camera views of object (A1) through (D1) to their alphanumeric, projector pairs: (A2) through (D2). Camera angles exhibit a degree of vertical and axonometric range of capture. The system can be comprised of one or several camera angles and projector pairs. While the number of cameras and camera angles are specific to this particular system, variations in capture prism design may require any number of cameras, capture angles, and projectors.

FIG. 9 is a diagram illustrating a method for capturing different segments of a three-dimensional object in sequential states of rotation to re-assemble the rotating segments as a rotating 3-D object when re-composited by the projectors on the capture prism (6). Camera (A1) through (D1) capture the real object and send the view angles to their alphanumeric projector pairs (A2) through (D2). This method is applied to pre-existing, 3-D motion graphics with a fixed point of view. Rotational increments in the diagram are 90-degree rotations of traditionally formatted, computer motion graphics, which cameras (A1) through (D1) capture sequentially at every 90-degree rotation of the 3-D graphic or 0°, 90°, 180°, and 270° camera angle views and send the information to projector (A2) through (D2) to reassemble a rotating, motion graphic from all sides. While the number of cameras and camera angles are specific to this particular system, variations in capture prism design may require any number of cameras, methods of capture, capture angles, and/or projectors.

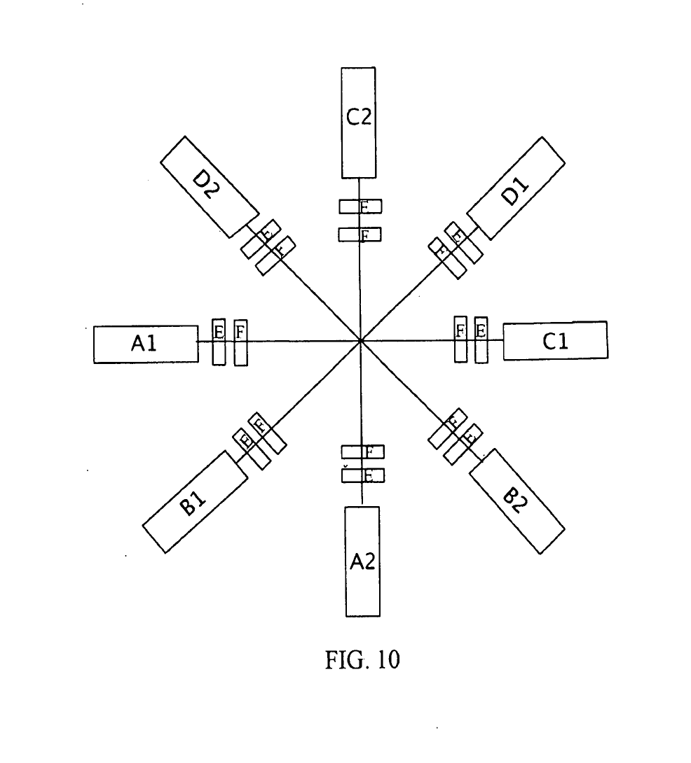

FIG. 10 is a diagram illustrating a method for generating 3-D virtual objects without a mirror assembly and/or target object though the use of several mixed-polarized scanned RGB laser projectors (A1/A2) through (D1/D2) and/or RGB lasers (A1/A2) through (D1/D2) using linear, circular, and/or orthogonal polarized filters (E) and/or wave plates (F) at optimal angles to create 3-D virtual objects. This method is achieved through timing circuits, micro-processors, and/or computer controls which switch and multiplex the oppositely polarized, coupled, alphanumeric, laser and/or laser projector pairs (A1/A2-D1/D2) at sufficiently high, sequential, frame rates to create the semblance of a volumetric object. Laser and or laser projector pairs (A1/A2), (B1/B2), (C1/C2), and (D1/D2) are positioned at the optimal angles and their beams are pulsed at such a rate that only one pair is active at any given fraction of time unless variations in design require otherwise. The switching rate between the polarized coupled pairs in conjunction with the persistence of human vision produces a volumetric form which appears to be constant from all sides. Polarized interference patterns produce stereoscopic content, which converges at a single or several points to form a 3-D object or event. While the number and arrangement of RGB laser pairs, RGB laser projector pairs, polarized filters and/or wave plates are specific to this design, variations in design may require any number of configurations and arrangements of existing or additional components which are required.

### 4. How to Use the Invention

The problems addressed by the Holoscope are as many as can be seen by those familiar with the current state of the art. Because the Holoscope does not depend on optical substrates, enclosures, or current holographic technology and generates an auto-stereoscopic, 3D, virtual object by means of interference patterns, several limitations of holographic technology have been avoided. The Holoscope can project a high definition, auto-stereoscopic, three-dimensional, virtual form on three-dimensional space without the need of a headset, enclosure, film, foil, emulsive medium or liquid crystal display. The Holoscope contains no moving parts and as such is less susceptible to mechanical failure. The device is capable of supporting whatever resolution and frame rate is projected through it by the micro-projectors (3). The projected virtual object is visible in normal room light conditions and produces an auto-stereoscopic, 3D, virtual form that appears to float in the air. The device supports several graphical interfaces. It can display auto-stereoscopic, 3D motion graphics and dynamic systems in accurate volumetric detail. It's capacity for generating an auto-stereoscopic, 3D object from a single projector (2), observable from a fixed position, allows conventional graphics to be used and converted to 3D. Its multiple projector array (3) generates a 3-D object, which is observable from 360 degree horizontal axis. It allows a stereoscopic 3-D form to be observed from above and below.

Thus it will be appreciated by those skilled in the art that the present invention is not restricted to the particular preferred embodiments described with reference to the drawings, and that variations may be made therein without departing from the scope of the present invention as defined in the appended claims and equivalents thereof.

What is claimed is:

1. A digital virtual object projector comprising: a device capable of projecting an auto-stereoscopic, 3D, high-resolution object or form on three dimensional space; a target object which works in conjunction with a single or several projectors in a mirror assembly to produce a digital object or form viewable from a fixed angle or several angles; an array of micro-projectors which at an appropriate angle and distance form the target object produce a digital 3-D object visible from multiple sides; and said array comprising a plurality of multiplexed and independently addressable micro-projectors working in tandem to produce a composite projection, comprised of individual segments projected by individual micro-projectors.

2. A digital virtual object projector according to claim 1, wherein said device produces a unique form of auto-stereoscopic, virtual imaging and spatially augmented reality.

3. A digital virtual object projector according to claim 1, wherein said device is modular and can work with a matrix of identical devices of varying scale to produce an immersive virtual reality environment.

4. A digital virtual object projector according to claim 1, wherein said device has a means for projecting onto the target sphere using a single micro-projector, thereby providing a means for an auto-stereoscopic, 3D virtual image to be projected onto three-dimensional space.

5. A digital virtual object projector according to claim 1, wherein said device is observable by a viewer in a fixed position and supports traditional graphic systems.

6. A digital virtual object projector according to claim 1, wherein said device has a means for projecting onto a target object using several micro-projectors to create a composite object or form projected onto three-dimensional space.

7. A digital virtual object projector according to claim 6, wherein said device is observable to one or more viewers from multiple sides.

8. A digital virtual object projector according to claim 1, wherein said device has a target object, which works in conjunction with other components and specially formatted visual data to act as a screen for the projected information.

9. A digital virtual object projector according to claim 1, wherein said device has a means for integrating a single or several micro-projectors and a target object with a mirror assembly to produce an auto-stereoscopic, digital virtual form or object.

10. A digital virtual object projector according to claim 1, wherein said device has a means for projecting three-dimensional digital virtual forms onto three-dimensional space at whatever resolution or frame rate is projected through it.

11. A digital virtual object projector according to claim 1, wherein said device has a means for projecting three-dimensional digital virtual forms without the need of an optical substrate.

12. A digital virtual object projector according to claim 1, wherein said device has a means for coordinating an array of several projectors to project onto a target object to assemble a composite form.

13. A digital virtual object projector according to claim 1, wherein said device has a target object which works as a 3D projection screen for a single projector or an array of several projectors.

14. A digital virtual object projector according to claim 1, wherein said device has a target object that is converted into a virtual object by the parabolic mirror configuration.

15. A digital virtual object projector according to claim 1, wherein said device has a target object, which is a reflective sphere or other form of regular or irregular polyhedra.

16. A digital virtual object projector according to claim 1, wherein said device has both a scalable target object and mirror assembly, which converts a target object into an auto-stereoscopic virtual object.

17. A digital virtual object projector according to claim 1, wherein said device has a means of integration with third party hardware and software.

18. A digital virtual object projector according to claim 1, wherein said device can be interfaced with haptic technology.

19. A digital virtual object projector according to claim 1, wherein said device is portable and can be used for fieldwork.

20. A digital virtual object projector according to claim 1, wherein said device is scalable either by increasing the diameter of parabolic mirror assembly, variations in parabolic mirror depth, segmented mirrors, or optical augmentation.

21. A method for using a digital virtual object projector comprising the steps of: designing a specific informational format, which corresponds to the target object's geometry; an intermediate device, which can make real time conversions from a variety of inputs and sources into said Format, connecting the digital virtual object to another device through HDMI, DVI, or whatever next generation connectors may exist, including current and next generation forms of wireless connections to compatible devices, including both intermediary devices and sources.

22. A digital virtual object projector according to claim 21, wherein said device has a design specific informational format, which works on several levels integral to the device's operation comprising:
a negative space format, which mimics the surrounding atmosphere, neutralizing the background surrounding the projected object, and making it appear to float in space; a segmentation/compositing format, which divides the projected virtual form into segments; which are projected by multiple projectors at the target object to assemble a composite form; a triangular matting format that triangulates the individual sections projected on the target sphere; a meshing format that corrects for spherical aberration on the projection surface; and a recessing format that recesses the projected form inside the target object.

23. A digital virtual object projector according to claim 21, wherein said device has a segmented mirror assembly based upon interlocking polygonal segments (arrayed in periodic, aperiodic, or non-periodic tiling patterns) which provides variable focal point and wave front control of a virtual object and/or events.

24. A digital virtual object projector according to claim 21, wherein a segmented mirror assembly consists of two segmented mirrors interfaced with openings in the center of each mirror.

25. A digital virtual object projector according to claim 21, wherein the deformable mirror assembly is segmented and/or based on bimorph, membrane, MEMS, ferro fluid, or continuous faceplate concepts.

26. A digital virtual object projector according to claim 21, wherein mechanical mechanisms attached to the segmented mirror assembly contract and expand polygonal segments to control the wave front of light and focal point of the virtual object.

27. A digital virtual object projector according to claim 21, wherein a non-linear meta-surface mirror and/or other lens/mirror hybrid amplifies light frequencies and magnifies interference patterns generated by the segmented mirror array assembly thus permitting a decrease in mirror size.

28. A digital virtual object projector according to claim 21, wherein a non-linear meta-surface mirror and/or other lens/mirror hybrid are constructed of a lightweight material, which is not subject to normal properties and/or limitations of solid mirrors.

29. A digital virtual object projector according to claim 21, wherein target object is a capture prism, working in conjunction with the segmented mirror assembly to project a volumetric object or event.

30. A digital virtual object projector according to claim 8, wherein target object is a capture prism (cylinder prism) with internal reflective curvature to convert volumetric sections to composite volumetric forms.

31. A digital virtual object projector according to claim 8, wherein the target object is a capture prism in the form of a sectioned cylinder prism or other form of regular or irregular, polyhedral sectioned prism.

32. A digital virtual object projector according to claim 8, wherein the target object is a capture prism enclosing the axial intersection of two or more reflective projection screens within an optical substrate exhibiting properties of internal reflective curvature.

33. A digital virtual object projector according to claim 8, wherein the target object is a capture prism for laser based projectors to composite a 360 degree, volumetric object or event.

34. A digital virtual object projector according to claim 8, wherein the target object is a capture prism with an internal curvature, which increases the volumetric properties of images projected into it.

35. A digital virtual object projector according to claim 8, wherein a capture prism encloses an axial intersection of two or more reflective projection surfaces within an optical substrate that exhibits properties of internal reflective curvature.

36. A digital virtual object projector according to claim 8, wherein said device has a method for projecting three-dimensional sections of a virtual or real object from multiple sides on reflective surfaces within the capture prism.

37. A digital virtual object projector according to claim 21, wherein a software and/or hardware captures and re-composites real world and virtual, three-dimensional objects and events.

38. A digital virtual object projector according to claim 21, wherein a method exists for assembling three-dimensional real or virtual objects from 3-D segments of real or virtual objects.

39. A digital virtual object projector according to claim 21, wherein a method exists for interfacing device with a 3-D software, engines and/or object libraries.

40. A digital virtual object projector according to claim 21, a method exists for formatting different segments of a 3D object in sequential states of rotation to re-assemble as a rotating 3-D object.

41. A digital virtual object projector according to claim 21, wherein a method exists for interpolating three-dimensional objects from partial 3-D or 2-D objects and events.

42. A digital virtual object projector according to claim 11, wherein a method exists for generating 3-D objects and events using polarized lasers, lasers and/or laser projectors with polarization filters to create interference patterns without a mirror assembly and/or target object.
